(19) United States
(12) Patent Application Publication
(10) Pub. No.: US 2025/0191862 A1
(43) Pub. Date: Jun. 12, 2025

(54) METAL ENCLOSED CIRCUIT BREAKER

(71) Applicant: Hitachi Energy Ltd, Zürich (CH)

(72) Inventors: Nils Henrik FURRER, Malmö (SE); Christoph WIRTH, Pfungen (CH); Robert VOSS, Zürich (CH); Mahesh DHOTRE, Brugg (CH); Rijo-Jude RAPHAEL, Zürich (CH)

(21) Appl. No.: 18/686,406

(22) PCT Filed: Aug. 22, 2022
(86) PCT No.: PCT/EP2022/073333

§ 371 Date: Feb. 24, 2024

(30) Foreign Application Priority Data
Aug. 26, 2021 (EP) 21193366.8

(51) Int. Cl. H01H 33/70; H01H 33/74; H01H 33/90

(52) U.S. Cl. CPC H01H 33/7015; H01H 33/74; H01H 2033/906

(57) ABSTRACT

The invention relates to a metal enclosed circuit breaker including
a first arcing contact and a second arcing contact, whereby the first arcing contact and/or the second arcing contact is axially movable along a switching axis, thereby forming, during a breaking operation, an arc between the first arcing contact and the second arcing contact in an arcing volume, and
an exhaust tube arranged in extension to the first arcing contact along the switching axis, whereby
the exhaust tube includes a closed rear end opposite to the first arcing contact connectable to a rod for actuating the first arcing contact,
the exhaust tube includes a barrier element arranged within the exhaust tube defining a dead exhaust tube volume between barrier element and the rear end, and
the barrier element includes a hole extending through the barrier element.

### CROSS REFERENCE TO RELATED APPLICATIONS

This application is a 35 U.S.C. § 371 national stage application of PCT International Application No. PCT/EP2022/073333 filed on Aug. 22, 2022, which in turn claims foreign priority to European Patent Application No. 21193366.8, filed on Aug. 26, 2021, the disclosures and content of which are incorporated by reference herein in their entirety.

### TECHNICAL FIELD

The disclosure relates to a metal enclosed circuit breaker comprising a first arcing contact and a second arcing contact, whereby the first arcing contact and/or the second arcing contact is axially movable along a switching axis, thereby forming, during a breaking operation, an arc between the first arcing contact and the second arcing contact in an arcing volume, and an exhaust tube arranged in extension to the first arcing contact along the switching axis. The disclosure further relates to a method for ventilating an exhaust tube of a metal enclosed circuit breaker comprising a first arcing contact and a second arcing contact, whereby the first arcing contact and/or the second arcing contact is axially movable along a switching axis, thereby forming, during a breaking operation, an arc between the first arcing contact and the second arcing contact in an arcing volume, whereby the exhaust tube is arranged in extension to the first arcing contact along the switching axis.

### BACKGROUND

Circuit breakers are known in the field of medium and high voltage switching applications and are predominantly used for interrupting a current, when an electrical fault occurs. As an example, circuit breakers have the task of opening contacts and keeping them apart from one another in order to avoid a current flow even in case of high electrical potential originating from the electrical fault itself. The circuit breaker may break medium to high short circuit currents of 1 kA to 80 kA at medium to high voltages of 12 kV to 72 kV and up to 1200 kV. The operation principle of circuit breakers is known. Such circuit breakers are arranged in the respective electrical circuits which are intended to be interrupted based on some predefined event occurring in the electrical circuit.

Generally, operation of such circuit breakers is responsive to detection of a fault condition or fault current. On detection of such a fault condition or fault current, a mechanism may operate the circuit breaker so as to interrupt the current flowing there through, thereby interrupting the current flowing in the electrical circuit. Once a fault is detected, contacts within the circuit breaker separate in order to interrupt the electrical circuit. Often spring arrangements, pneumatic arrangements or some other means utilizing mechanically stored energy are employed to separate the contacts. Some of the energy required for separating the contacts may be obtained from the fault current itself. When interrupting the current flowing in the electrical circuit, an arc is generally generated. This arc must be cooled so that it becomes quenched or extinguished, such that the gap between the contacts repeatedly can withstand the voltage in the electrical circuit. It is known to use, air, oil or insulating gas as medium in which the arc forms. Insulating gas comprises for example Sulphur hexafluoride (SF6) or CO2.

In metal-enclosed breakers, hot insulating gas from the arc-zone escapes towards an exhaust volume provided at an end portion of the circuit breaker. The insulating gas is then cooled by mixing with cold insulating gas and released into a tank of the circuit breaker. Presence of ambient air or other types of gas inside the tank leads to a reduction of the insulation capability and thus need to be avoided. Thus, prior to SF6 gas filling, the tank is evacuated to remove all remaining gas inside the breaker. Therefore, all major cavities need to be ventilated to enable for their evacuation.

In a death tank circuit breaker, DTB, application, a cone in an exhaust tube in prolongation of an arcing contact directs a gas flow into a hylsa volume, thereby dividing the exhaust volume into two volumes. While a first volume pointing towards a tulip is under high pressure and constitutes a hot gas region, a second volume provided by the exhaust tube pointing towards a push/pull rod rather constitutes a dead volume. For said ventilation, the exhaust tube is typically evacuated through an opening at a rear end. However, such ventilation requires that the cone is provided gas-tight in order to prevent hot gas leaking from the high pressure first volume region into the exhaust tube. Further, it is difficult to ensure that not hot gas leaks through such connection.

### SUMMARY

It is therefore an object of the disclosure to provide an improved circuit breaker that avoids gas leakage in an exhaust tube and to provide a respective method for improved ventilation of the exhaust tube.

The object of the disclosure is solved by the features of the independent claims. Preferred implementations are detailed in the dependent claims.

Thus, the object is solved by an in particular high or medium voltage and/or gas-insulated metal enclosed circuit breaker comprising
a first arcing contact and a second arcing contact, whereby the first arcing contact and/or the second arcing contact is axially movable along a switching axis, thereby forming, during a breaking operation, an arc between the first arcing contact and the second arcing contact in an arcing volume, and
an exhaust tube arranged in extension to the first arcing contact along the switching axis, whereby
the exhaust tube comprises a closed rear end opposite to the first arcing contact connectable to a rod for actuating the first arcing contact,
the exhaust tube comprises a barrier element arranged within the exhaust tube defining a dead exhaust tube volume between barrier element and the rear end, and
the barrier element comprises a hole extending through the barrier element.

A key point of the disclosure is therefore that, compared to prior art, ventilation of the exhaust tube is basically shifted from a clutch of the exhaust tube towards a barrier element inside the exhaust tube by introducing a hole on the barrier element. Thereby, any potential gas leakage into a support insulator volume of the circuit breaker is prevented by designing the rear end closed. The hole provides a defined gas flow in between two exhaust volumes provided by the exhaust tube and the arcing volume. In other words, compared to prior art, the ventilation hole is shifted from an exhaust tube armature and/or clutch to a cone inside the exhaust tube. Consequently, the design of the exhaust clutch becomes in particular gas tight. Such way the insulation capability of the circuit breaker is improved as ambient air is more effectively evacuated.

The term high or medium voltage relates to voltages that exceeds 1 kV. A medium voltage preferably concerns nominal voltages in the range from 12 kV to 72 kV (medium voltage range), like 25 kV, 40 kV or 60 kV. A high voltage preferably relates to nominal voltages in the range from above 72 kV to 550 kV, like 145 kV, 245 kV or 420 kV. Nominal currents of the circuit breaker can be preferably in the range from 1 kA to 5 kA. The current which flows during the abnormal conditions in which the circuit breaker performs its duty may be appropriately referred to as referred to as the breaking current or the short circuit current. The short circuit current may be in the range from 31.5 kA to 80 kA, which is termed high short-circuit current duty. During a breaking operation, breaking voltages may be very high, e.g., in the range from 110 kV to 1200 kV.

In a gas-insulated circuit breaker, the arc-extinguishing medium comprises a gas. First side shield, first side cylinder, second side shield, second side/cylinder and/or chamber insulating tube form an encapsulating housing which defines a volume for the gas. According to some embodiments, the circuit breaker can include a gas blowing system configured to extinguish an arc formed between the first arcing contact and the second arcing contact of the circuit breaker during a stage of the current interruption operation. In some embodiments, the first arcing contact, the first side cylinder and/or first side shield may be movable, whereas the second arcing contact, the second side cylinder and/or second side shield may be fixed.

The arc-extinguishing gas can be any suitable gas that enables to adequately extinguish the electric arc formed between the arcing contacts during a current interruption operation, such as, but not limited, to an inert gas as, for example, sulphur hexafluoride SF6. Thereby, the arc between the first and second arcing contacts develops in the arcing region. Specifically, the arc-extinguishing gas used in the circuit breaker can be SF6 gas or any other dielectric insulation medium, may it be gaseous and/or liquid, and in particular can be a dielectric insulation gas or arc quenching gas. Such dielectric insulation medium can for example encompass media comprising an organofluorine compound, such organofluorine compound being selected from the group consisting of: a fluoroether, an oxirane, a fluoroamine, a fluoroketone, a fluoroolefin, a fluoronitrile, and mixtures and/or decomposition products thereof. Herein, the terms “fluoroether”, “oxirane”, “fluoroamine”, “fluoroketone”, “fluoroolefin” and “fluoronitrile” refer to at least partially fluorinated compounds. In particular, the term “fluoroether” encompasses both hydrofluoroethers and perfluoroethers, the term “oxirane” encompasses both hydrofluorooxiranes and perfluorooxiranes, the term “fluoroamine” encompasses both hydrofluoroamines and perfluoroamines, the term “fluoroketone” encompasses both hydrofluoroketones and perfluoroketones, the term “fluoroolefin” encompasses both hydrofluoroolefins and perfluoroolefins, and the term “fluoronitrile” encompasses both hydrofluoronitriles and perfluoronitriles. Some embodiments provide that it can thereby be that the fluoroether, the oxirane, the fluoroamine and the fluoroketone are fully fluorinated, i.e. perfluorinated.

The dielectric insulation medium can be selected from the group consisting of: a hydrofluoroether, a perfluoroketone, a hydrofluoroolefin, a perfluoronitrile, and mixtures thereof. In particular, the term “fluoroketone” as used in the context of the present disclosure shall be interpreted broadly and shall encompass both fluoromonoketones and fluorodiketones and/or generally fluoropolyketones. Explicitly, more than a single carbonyl group flanked by carbon atoms may be present in the molecule. The term shall also encompass both saturated compounds and unsaturated compounds including double and/or triple bonds between carbon atoms. The at least partially fluorinated alkyl chain of the fluoroketones can be linear or branched and can optionally form a ring. The dielectric insulation medium may comprise at least one compound being a fluoromonoketone and/or may also comprise heteroatoms incorporated into the carbon backbone of the molecules, such as at least one of: a nitrogen atom, oxygen atom and sulphur atom, replacing one or more carbon atoms. In some embodiments, the fluoromonoketone, in particular perfluoroketone, can have from 3 to 15 or from 4 to 12 carbon atoms and particularly from 5 to 9 carbon atoms. In some embodiments, it may comprise exactly 5 carbon atoms and/or exactly 6 carbon atoms and/or exactly 7 carbon atoms and/or exactly 8 carbon atoms.

Further, the dielectric insulation medium may comprise at least one compound being a fluoroolefin selected from the group consisting of: hydrofluoroolefins (HFO) comprising at least three carbon atoms, hydrofluoroolefins (HFO) comprising exactly three carbon atoms, trans-1,3,3,3-tetrafluoro-1-propene (HFO-1234ze), 2,3,3,3-tetrafluoro-1-propene (HFO-1234yf), and mixtures thereof. The organofluorine compound can also be a fluoronitrile, in particular a perfluoronitrile. In particular, the organofluorine compound can be a fluoronitrile, specifically a perfluoronitrile, containing two carbon atoms, and/or three carbon atoms, and/or four carbon atoms. More particularly, the fluoronitrile can be a perfluoroalkylnitrile, specifically perfluoroacetonitrile, perfluoropropionitrile (C2F5CN) and/or perfluoro-butyronitrile (C3F7CN). Most particularly, the fluoronitrile can be perfluoroisobutyronitrile (according to the formula (CF3)2CFCN) and/or perfluoro-2-methoxypropanenitrile (according to formula CF3CF(OCF3)CN). Of these, perfluoroisobutyronitrile (i.e. 2,3,3,3-tetrafluoro-2-trifluoromethyl propanenitrile alias i-C3F7CN) is particularly preferred due to its low toxicity. The dielectric insulation medium can further comprise a background gas or carrier gas different from the organofluorine compound (in particular different from the fluoroether, the oxirane, the fluoroamine, the fluoroketone and the fluoroolefin) and can in embodiments be selected from the group consisting of: air, N2, O2, CO2, a noble gas, H2; NO2, NO, N2O; fluorocarbons and in particular perfluorocarbons, such as CF4; CF3I, SF6; and mixtures thereof. For example, the dielectric insulating gas can be CO2 in an embodiment.

The circuit breaker may include one or more components such as, a puffer-type cylinder, a self-blast chamber, a pressure collecting space, a compression space, or puffer volume, and an expansion space. The circuit breaker may effectuate interruption of the electrical circuit by means of one or more of such components, thereby discontinuing flow of electrical current in the electrical circuit, and/or extinction of the arc produced when the electrical circuit is interrupted. The circuit breaker can include also other parts such as a drive, a controller, and the like, which have been omitted in the description. These parts are provided in analogy to a conventional high or medium voltage gas-insulated circuit breaker. The term “axial” designates an extension, distance etc. in the direction of the axis. An axial separation between parts means that these parts are separated from each other when seen or measured in the direction of the axis. The term “radial” designates an extension, distance etc. in a direction perpendicular to the axis. The term “cross-section” means a plane perpendicular to the axis, and the term “cross-sectional area” means an area in such a plane. The axis can be, for example, the switching axis.

In an implementation according to some embodiments, the hole extends axially along the switching axis. The hole is provided as a bore and/or the barrier element comprises a plurality of holes. In some embodiments, the hole is provided as through hole and/or extends in axial direction. In some embodiments, the hole comprises a diameter of 1, 2, 3, 5 or 10 mm. In some embodiments, the plurality of holes are arranged in a regular patterns, for example in a ring-like manner. In some embodiments the plurality of holes are arranged distant to each other.

According to a further implementation the barrier element is provided as a cone or as a frustrum. By such cone gas flow can be advantageously directed into a hylsa volume. A radial diameter of the cone preferably matches a diameter of the exhaust tube. In some embodiments, the cone is provided, except the hole, gas-tight and/or pressure-tight with the exhaust tube. The cone shaped barrier element is preferably pointed towards the arcing volume. The conicity given by angle α preferably ranges between 20° and 90°, being preferably of 35°, more preferred of 45°, most preferred of 55°, with respect to the switching axis. It is furthermore provided that a tip of the cone or edges of the small base of the frustum, respectively, may be rounded in order to avoid increased erosion and enhance a smooth gas flow. Further, the barrier element in a cone-implementation preferably tapers by a constant rate or a non-constant rate from its base to the apex, or the barrier element in a frustum-implementation tapers by a constant rate or a non-constant rate from its large base to its small base. Alternatively, the barrier element can be provided frustoconical.

In another implementation the barrier element is spot-welded with the exhaust tube, in particular by means of spot-welding. With such spot-welding the barrier element a much simpler and thus cheaper manufacturing can be achieved instead of, for example, gas tight circumferential welding. In this respect the barrier element and the exhaust tube are preferably provided as metal products. Spot-welding may be conducted through a process in which contacting metal surface points of the barrier element and the exhaust tube are joined by heat obtained from resistance to electric current.

According to a further implementation the rear end is closed gas-tight and/or pressure-tight. In some embodiments, the rear end is provided as exhaust clutch and/or connected to a push/pull rod for actuating the first arcing contact. In some embodiments, the rear end is closed by welding. The exhaust tube may include a rounded shape as drawn tube.

In another implementation the circuit breaker includes a first nominal contact circumferentially surrounding the first arcing contact and a second nominal contact circumferentially surrounding the second arcing contact, whereby the first nominal contact defines a heating volume connected to the arcing volume for housing an insulating fluid for quenching the arc.

The object is further solved by a method for ventilating an exhaust tube of a metal enclosed circuit breaker comprising a first arcing contact and a second arcing contact, whereby the first arcing contact and/or the second arcing contact is axially movable along a switching axis, thereby forming, during a breaking operation, an arc between the first arcing contact and the second arcing contact in an arcing volume, whereby
the exhaust tube is arranged in extension to the first arcing contact along the switching axis,
the exhaust tube comprises a closed rear end opposite to the first arcing contact connectable to a rod for actuating the first arcing contact,
the exhaust tube comprises a barrier element arranged within the exhaust tube defining a dead exhaust tube volume between barrier element and the rear end, and comprising the step of:
Ventilating the dead exhaust tube volume through a hole extending through the barrier element.

By such ventilating, ambient air can be removed from the exhaust tube respectively from the dead exhaust tube volume, thereby leading to an increased insulation capability of the circuit breaker.

In some embodiments the ventilating comprises evacuating the exhaust tube. In another implementation the hole extends axially along the switching axis, the hole is provided as bore and/or the barrier element comprises a plurality of holes. In a further implementation, the barrier element is provided as cone.

In another implementation the method comprises the step of:
Spot-welding the barrier element with the exhaust tube.

According to a further implementation the method comprises the step of:
Gas-tight and/or pressure-tight closing the rear end.

In another implementation the metal enclosed circuit breaker comprises a first nominal contact circumferentially surrounding the first arcing contact and a second nominal contact circumferentially surrounding the second arcing contact, whereby the first nominal contact defines a heating volume connected to the arcing volume for housing an insulating fluid for quenching the arc.

Further implementations and advantages of the method are directly and unambiguously derived by the person skilled in the art from the circuit breaker as described before.

### BRIEF DESCRIPTION OF DRAWINGS

These and other aspects of the disclosure will be apparent from and elucidated with reference to the implementations described hereinafter.

In the drawings:

FIG. 1 shows a metal enclosed circuit breaker according to a preferred implementation in a schematic cross-sectional view, and

FIG. 2 shows an exhaust tube of the circuit breaker of FIG. 1 according to the preferred implementation in a schematic cross-sectional view.

### DESCRIPTION OF IMPLEMENTATIONS

Although the following description is given with respect to a metal enclosed circuit breaker 1, and particularly with respect to a gas-insulated high or medium voltage circuit breaker 1 for medium and high voltage applications, it is to be understood that the implementations of the present disclosure are not limited thereto. Instead, the present implementations could be applied anywhere where a metal enclosed circuit breaker respectively gas-insulated circuit breaker 1 is needed. For simplicity, implementations described herein often refer to a circuit breaker 1, instead of referring to a metal enclosed circuit breaker or gas-insulated high or medium circuit breaker 1. The circuit breaker 1 may be a puffer type circuit breaker, a self-blast circuit breaker, a generator circuit breaker, a disconnector, a combined disconnector and circuit breaker, a live tank breaker, or a load break switch in power transmission and distribution systems. The circuit breaker 1 can comprise also other parts such as nominal contacts 7, 8 described below, a drive, a controller, and the like, which have been omitted in the figures and are not described herein in detail. These parts are provided in analogy to a conventional high or medium voltage gas-insulated circuit breaker.

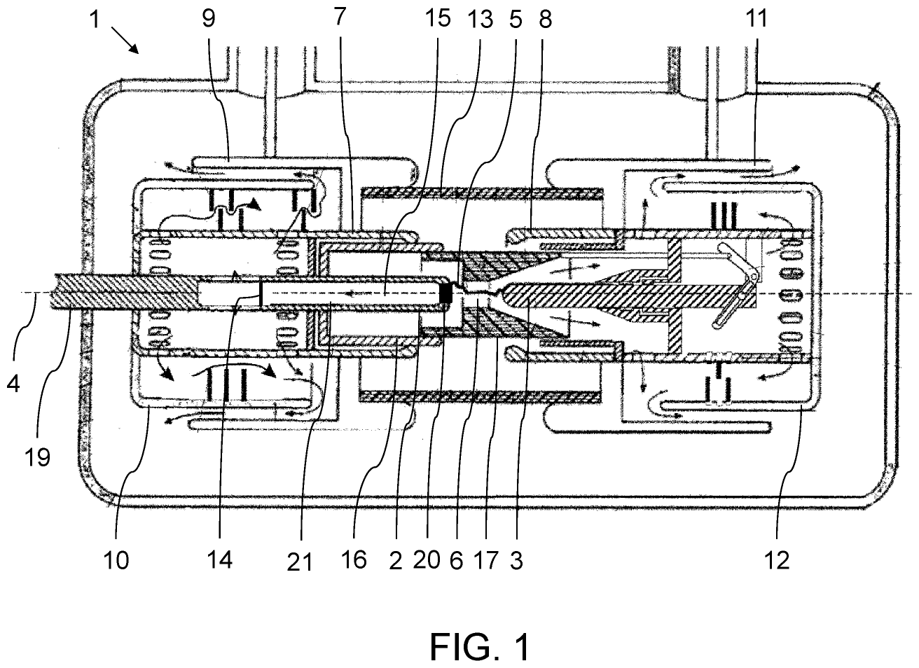

FIG. 1 shows a metal enclosed circuit breaker 1 according to some implementations described herein, for high or medium voltages. The circuit breaker 1 includes a first arcing contact 2 and a second arcing contact 3. The first arcing contact 2 is in FIG. 1 exemplarily in the form of a tulip, e.g. a contact tulip, whereby the second arcing contact 3 is in the form of a rod, e.g. a contact rod. The two arcing contacts 2, 3 co-operate with each other between an open end-position, in which the two arcing contacts 2, 3 are completely electrically separated from each other, as shown in FIG. 1, and a closed end-position, in which an electric current can pass between them. The moving acing contact 2 is part of a moving breaking contact having a first nominal contact 7. Further, the second arcing contact 3 is part of a fixed breaking contact with a second nominal contact 8.

The arcing contacts 2, 3 are constituted in a manner such that they can conveniently carry an interruption current, so that the arcing contacts 2, 3 do not generate excessive heating and withstand the heat of an arc 5 generated during a current interruption operation of the circuit breaker 1. In particular, arcing contacts 2, 3 are made of any suitable material, typically arc-resistant material, that enables the circuit breaker 1 to function as described herein, such as exemplarily, but not limited to: copper, copper alloys, silver alloys, tungsten, tungsten alloys, or any combination(s) thereof. In particular, these materials are chosen on the basis of their electrical conductivity, hardness (i.e. resistance to abrasive wear), mechanical strength, low cost, and/or chemical properties. For example, the contact rod shown in FIG. 1 and forming the second arcing contact 3 is made of any suitable conductive material which enables the circuit breaker 1 to function as described herein, such as, for example, but not limited to, copper. If required, the contact rod may be made of different materials, for example, different parts thereof may be made of different materials or be coated with a material which provides adequate electrical and/or mechanical properties to each of these parts.

As indicated by arrows in FIG. 1, the first arcing contact 2 e.g. as part of the moving breaking contact, is movable relatively to the second arcing contact 3 along a switching axis 4 to bring the arcing contacts 2, 3 in the open end-position or in the closed end-position. In the closed end-position, the second arcing contact 3 is inserted into the first arcing contact 2. During the breaking operation, the first arcing contact 2 moves away from the second arcing contact 3 so that both contacts separate from one another. During the breaking operation, as shown in FIG. 1, arc 5 develops in the arcing region 6 between portions of the first and second arcing contact 2, 3.

The circuit breaker 1 shown in FIG. 1 is arranged in a gas-tight housing filled with an electrically insulating gas or arc-extinguishing gas. The volume between the housing and the components of the circuit breaker 1 shown in FIG. 1 is inside the gastight housing. The gas-tight housing can be constituted as an encapsulation, such as, but not limited to, a metallic or ceramic housing. The encapsulation comprises a first side shield 9 and a first side cylinder 10 overlappingly arranged and circumferentially surrounding the first nominal contact 7, and a second side shield 11 and a second side cylinder 12 overlappingly arranged and circumferentially surrounding the second nominal contact 8. A chamber insulating tube 13 circumferentially connects the first side shield 9 and the second side shield 11 around the arcing region 6 in an overlapping manner. The circuit breaker 1 further comprises a buffer cylinder 16 including a channel directed to the arcing region 6 and a nozzle 17 for blowing during the breaking operation the arc-extinguishing gas to the arcing region 6.

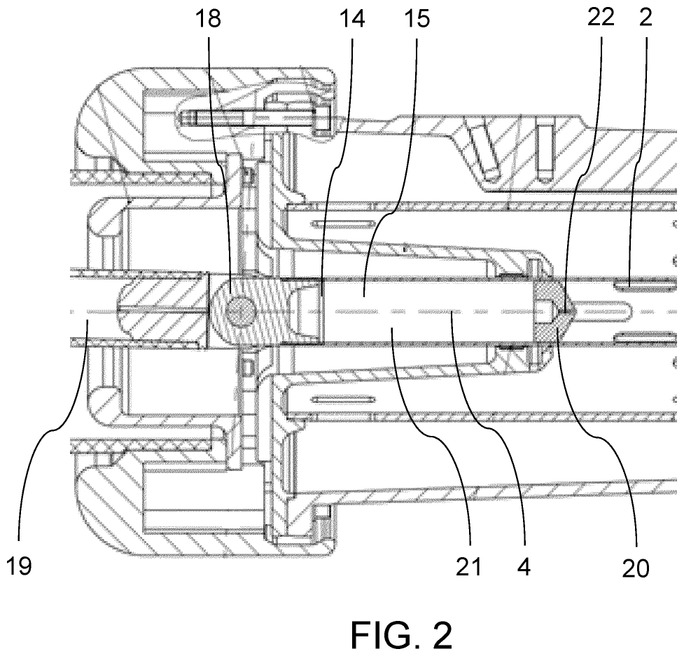

FIG. 2 shows an exhaust tube 15 arranged in extension to the first arcing contact 2 along the switching axis 4 of the circuit breaker of FIG. 1 in a schematic cross-sectional view. The exhaust tube 15 comprises a closed rear end 14 opposite to the first arcing contact 2, which is connected via an exhaust tube armature/clutch 18 to a push/pull rod 19 for actuating the first arcing contact 2. The rear end 14 is closed by closed gas-tight and pressure-tight in respect to a cylinder-like dead exhaust tube volume 21 defined by the exhaust tube 15 and the rear end 14.

Opposite to the rear end 14 facing the arcing region 6 a barrier element 20 is arranged thereby limiting the dead exhaust tube volume 21 on said other side. The barrier element 20 is provided as cone, whereby the radial diameter of the barrier element 20 matches a diameter of the exhaust tube 15. The cone shaped barrier element 20 is pointed towards the arcing volume 6 with a conicity given by angle α of 55° with respect to the switching axis 4. The cone is spot-welded with the exhaust tube 15. Within the barrier element 20 a hole 22 is provided, which extends in axial direction matching the switching axis 4, through the barrier element 20 as through bore. While FIG. 2 shows a single hole 22, a plurality of holes 22 can be provided arranged in regular distances to each other. The hole 22 may comprise a diameter of 1, 2, 3, 5 or 10 mm.

Thus, as the dead exhaust tube volume 21 is provided gas-tight and pressure-tight except to the hole 22, hot gas cannot leak through the rear end 14 into a support insulator arranged axially behind the exhaust tube 15. Via the hole 22 the dead exhaust tube volume 21 can be evacuated from ambient air by which an insulation capability of the circuit breaker 1 is improved.

While the disclosure has been illustrated and described in detail in the drawings and foregoing description, such illustration and description are to be considered illustrative or example and not restrictive; the disclosure is not limited to the disclosed implementations. Other variations to be disclosed implementations can be understood and effected by those skilled in the art in practicing the claimed disclosure, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

1 circuit breaker
2 first arcing contact
3 second arcing contact
4 switching axis
5 arc
6 arcing region
7 first nominal contact
8 second nominal contact
9 first side shield
10 second side shield
11 first side cylinder
12 second side cylinder
13 chamber insulating tube
14 rear end
15 exhaust tube
16 buffer cylinder
17 nozzle
18 exhaust tube clutch
19 rod
20 barrier element
21 dead exhaust tube volume
22 hole

1. A metal enclosed circuit breaker comprising
a first arcing contact and a second arcing contact, whereby the first arcing contact and/or the second arcing contact is axially movable along a switching axis, thereby forming, during a breaking operation, an arc between the first arcing contact and the second arcing contact in an arcing volume, and
an exhaust tube arranged in axial extension to the first arcing contact along the switching axis, whereby
the exhaust tube comprises a closed rear end opposite to the first arcing contact, said closed rear end is connectable to a rod for actuating the first arcing contact,
the exhaust tube comprises a barrier element arranged within the exhaust tube defining a dead exhaust tube volume between the barrier element and the rear end, and
the barrier element comprises a hole extending through the barrier element.

2. The metal enclosed circuit breaker according to claim 1, whereby the hole extends axially along the switching axis, the hole is provided as a bore and/or the barrier element comprises a plurality of holes.

3. The metal enclosed circuit breaker claim 1, whereby the barrier element is provided as a cone, preferably having a conicity defined by an angle α ranging between 20° and 90°, preferably of 35°, more preferred of 45°, most preferred of 55°, with respect to the switching axis.

4. The metal enclosed circuit breaker according to claim 1, whereby the barrier element is spot-welded with the exhaust tube.

5. The metal enclosed circuit breaker according to claim 1, whereby the rear end is closed gas-tight and/or pressure-tight.

6. The metal enclosed circuit breaker according to claim 1, whereby the hole comprises a diameter of 1, 2, 3, 5 or 10 mm.

7. A method for ventilating an exhaust tube of a metal enclosed circuit breaker comprising a first arcing contact and a second arcing contact, whereby the first arcing contact and/or the second arcing contact is axially movable along a switching axis, thereby forming, during a breaking operation, an arc between the first arcing contact and the second arcing contact in an arcing volume, whereby
the exhaust tube is arranged in extension to the first arcing contact along the switching axis,
the exhaust tube comprises a closed rear end opposite to the first arcing contact, said closed rear end is connectable to a rod for actuating the first arcing contact,
the exhaust tube comprises a barrier element arranged within the exhaust tube defining a dead exhaust tube volume between the barrier element and the rear end, and comprising the step of:
ventilating the dead exhaust tube volume through a hole extending through the barrier element.

8. The method according to claim 7, whereby the ventilating comprises evacuating the exhaust tube.

9. The method according to claim 7, whereby the hole extends axially along the switching axis, the hole is provided as bore and/or the barrier element comprises a plurality of holes.

10. The method according to claim 7, whereby the barrier element is provided as cone.

11. The method according to claim 7, comprising the step of:
Spot-welding the barrier element with the exhaust tube.

12. The method according to claim 7, comprising the step of:
Gas-tight and/or pressure-tight closing the rear end.

13. The method according to claim 7, whereby the metal enclosed circuit breaker comprises a first nominal contact circumferentially surrounding the first arcing contact and a second nominal contact circumferentially surrounding the second arcing contact, whereby the first nominal contact defines a heating volume connected to the arcing volume for housing an insulating fluid for quenching the arc.

14. The method of claim 7, whereby the barrier element is provided as a cone having a conicity defined by an angle α ranging between 20° and 90° with respect to the switching axis.

15. The method of claim 7, whereby the barrier element is provided as a cone having a conicity defined by an angle α ranging between 35° and 90° with respect to the switching axis.

16. The method of claim 7, whereby the barrier element is provided as a cone having a conicity defined by an angle α ranging between 45° and 90° with respect to the switching axis.

17. The method of claim 7, whereby the hole comprises a diameter of 1, 2, 3, 5 or 10 mm.
